(19) United States
(12) Patent Application Publication
(10) Pub. No.: US 2017/0092222 A1
(43) Pub. Date: Mar. 30, 2017

(54) DISPLAY DEVICE AND DRIVING METHOD THEREOF

(71) Applicant: SAMSUNG DISPLAY CO., LTD., YONGIN-SI (KR)

(72) Inventors: WON TAE KIM, CHEONGJU-SI (KR); OK-KWON SHIN, SEOUL (KR)

(21) Appl. No.: 15/161,965

(22) Filed: May 23, 2016

(30) Foreign Application Priority Data
Sep. 25, 2015 (KR) 10-2015-0136704

(51) Int. Cl. G09G 5/00

(52) U.S. Cl. CPC G09G 5/003; G09G 2310/08; G09G 2310/027; G09G 2330/045; G09G 2310/0291; G09G 2370/10; G09G 2320/02; G09G 2320/041

(57) ABSTRACT

A display device includes: a timing controller for generating a data configuration packet including a temperature reference voltage bit, a self-adaptive bit, and a first heating control bit; a data driving IC including a digital signal processor and a temperature sensor; and a pixel portion connected to data lines for displaying an image. The temperature sensor senses a temperature, outputs an enable-level abnormal temperature detecting signal when a temperature sensed voltage indicating the temperature is greater than the temperature reference voltage. The digital signal processor generates a feedback heating control bit to reduce the temperature sensed voltage to a value less than the temperature reference voltage when the detecting signal is at the enable-level. The digital signal processor controls heating of the data driving IC irrespective of the first heating control bit and according to the feedback heating control bit when the self-adaptive bit is set to an ON state.

### CROSS-REFERENCE TO RELATED APPLICATION

This application claims priority under 35 USC §119 to Korean Patent Application No. 10-2015-0136704 filed in the Korean Intellectual Property Office (KIPO) on Sep. 25, 2015, the disclosure of which is incorporated by reference in its entirety herein.

### BACKGROUND

(a) Technical Field

The present disclosure relates to a display device and a driving method thereof.

(b) Discussion of Related Art

A display device may include a liquid crystal display and an organic light emitting display. A liquid crystal display is a display device that uses the light-modulating properties of liquid crystals to display images. An organic light emitting display is display device that includes an emissive electroluminescent layer that emits light in response an electric current.

Each display device may include at least one data driving integrated circuit (IC). Each data driving IC is connected to a pixel portion of the display device through a plurality of data lines.

The data driving IC may become overheated depending on the input image pattern it supplies to a portion of a display panel of the display device. For example, the data driving IC may become overheated when output power of an amplifier included in the data driving IC is excessive.

When a display device includes a plurality of data driving ICs, heating of each of the data driving ICs may be individually controlled. However, when this technique is used, the luminance is different for respective display areas corresponding to the data driving ICs, which may cause a plurality of blocks to be perceived by a viewer of the display.

### SUMMARY

At least one embodiment of the present inventive concept has been made in an effort to provide a display device that controls the heating of its data driving ICs corresponding to various image patterns, and prevents display areas corresponding to the data driving ICs from being perceived as blocks by a viewer, and a driving method thereof.

An exemplary embodiment of the present inventive concept provides a display device including: a timing controller for generating a data configuration packet including a temperature reference voltage bit, a self-adaptive bit, and a first heating control bit; a data driving IC including a digital signal processor for processing the data configuration packet and a temperature sensor, and applying a data voltage corresponding to the data configuration packet to a plurality of data lines; and a pixel portion connected to the data lines and displaying an image. The temperature sensor senses a temperature of the data driving IC and outputs at an enable-level abnormal temperature detecting signal when a temperature sensed voltage indicating the sensed temperature is greater than a temperature reference voltage associated with the temperature reference bit. The digital signal processor generates a feedback heating control bit to enable the temperature sensed voltage to be less than the temperature reference voltage. The digital signal processor controls heating of the data driving IC irrespective of the first heating control bit and according to the feedback heating control bit when the self-adaptive bit is set to an ON state and the abnormal temperature detecting signal is enable-level.

The digital signal processor may control heating of the data driving IC based on the first heating control bit when the self-adaptive bit is set to an OFF state.

The temperature sensor may set the abnormal detecting signal to a disable-level when the temperature sensed voltage is less than or equal to the temperature reference voltage.

The data driving IC may further include: a digital-to-analog converter for converting a digital image signal output by the digital signal processor into an analog image signal; and an output buffer including a plurality of amplifiers corresponding to the data lines, the amplifiers amplifying the analog image signal and outputting the data voltage, where the digital signal processor controls an amplification ratio of the amplifiers according to an amplification ratio control bit present within the first heating control bit to control heating of the data driving IC.

The data driving IC may further include a charge sharing unit electrically provided between the output buffer and the data lines and performing charge sharing between adjacent data lines during a period corresponding to the charge sharing period control bit, where the digital signal processor controls the charge sharing unit according to a charge sharing period control bit present in the first heating control bit to control heating of the data driving IC.

The display device may further include at least one other data driving IC, where the timing controller receives feedback heating control bits generated by the data driving ICs as feedback and may set the feedback heating control bit corresponding to a maximum temperature from among the feedback heating control bits as a second heating control bit, and transmits a second configuration packet including the second heating control bit to all the data driving ICs for heating of the data driving ICs to be controlled by the second heating control bit. In an embodiment, the self-adaptive bit is set to the OFF state so that the second heating control bit is not ignored by the data driving ICs.

The second data configuration packet may include a frame configuration packet and a line configuration packet provided after the frame configuration packet, the frame configuration packet may include the temperature reference voltage bit and the self-adaptive bit, and the line configuration packet may include at least one of a charge sharing period control bit and an amplification ratio control bit.

A position of the first heating control bit in the data configuration packet may be the same as a position of the second heating control bit in the second data configuration packet.

An exemplary embodiment of the present inventive concept provides a method for driving a display device, including: transmitting, by a timing controller, a data configuration packet to a data driving IC, where the packet includes a temperature reference voltage bit, a self-adaptive bit, and a first heating control bit; sensing, by a temperature sensor of the data driving IC, a temperature of the data driving IC; outputting, by the temperature sensor, an abnormal temperature detecting signal at an enable-level when a temperature sensed voltage indicating the sensed temperature is greater than a temperature reference voltage associated with the temperature reference voltage bit; generating, by a digital signal processor of the data driving IC, a feedback heating control bit to enable the temperature sensed voltage to be less than the temperature reference voltage; and controlling, by the digital signal processor, heating of the data driving IC irrespective of the first heating control bit and according to the feedback heating control bit when the self-adaptive bit is set to an ON state and the abnormal temperature detecting signal is set to the enable-level.

The method may further include controlling amplification ratios of a plurality of amplifiers included in an output buffer of the data driving IC according to an amplification ratio control bit present in the first heating control bit to control heating of the data driving IC by the digital signal processor.

The method may further include controlling, by the digital signal processor, a charge sharing period of a charge sharing unit of the data driving IC according to a charge sharing period control bit present in first heating control bit to control heating of the data driving IC.

The method may further include: receiving, by the timing controller, feedback heating control bits generated by the data driving ICs as feedback; setting, by the timing controller, the feedback heating control bit corresponding to a maximum temperature from among the feedback heating control bits as the second heating control bit; and transmitting, by the timing controller, a second data configuration packet including the second heating control bit to all the data driving ICs for controlling heating of the data driving ICs according to the second heating control bit.

The second data configuration packet may include a frame configuration packet and a line configuration packet provided after the frame configuration packet, the frame configuration packet may include the temperature reference voltage bit and the self-adaptive bit, and the line configuration packet may include at least one of a charge sharing period control bit and an amplification ratio control bit.

A position of the first heating control bit in the data configuration packet may be the same as a position of the second heating control bit in the second data configuration packet.

According to an exemplary embodiment of the inventive concept, a driving apparatus for a display device is provided. The driving apparatus includes a timing controller for generating a data configuration packet including a temperature reference voltage bit, a self-adaptive bit, and a first heating control bit; a temperature sensor configured to sense a temperature, output an abnormal temperature detecting signal at an enable-level when a temperature sensed voltage indicating the sensed temperature is greater than a temperature reference voltage associated with the temperature reference bit; and a digital signal processor configured to generate a feedback heating control bit to enable the temperature sensed voltage to be less than the temperature reference voltage. The digital signal processor controls internal heating according to the first heating control bit when the self-adaptive bit is set to an OFF state and according to the feedback heating control bit when the self-adaptive bit is set to an ON state and when the abnormal temperature detecting signal is set to the enable-level.

According to an exemplary embodiment of the inventive concept, the temperature sensor sets the abnormal temperature detecting signal to a disable-level when the temperature sensed voltage is less than or equal to the temperature reference voltage.

According to at least one embodiment of the present inventive concept, a display device and a driving method thereof may control heating of a data driving IC corresponding to various image patterns, and may prevent display areas corresponding to a plurality of data driving ICs from being perceived as blocks when the data driving ICs are provided.

### BRIEF DESCRIPTION OF THE DRAWINGS

FIG. 1 shows a display device according to an exemplary embodiment of the inventive concept.

FIG. 2 shows a data driving IC according to an exemplary embodiment of the inventive concept.

FIG. 3 shows an operation of a temperature sensor according to an exemplary embodiment of the inventive concept.

FIG. 4 shows an output buffer according to an exemplary embodiment of the inventive concept.

FIG. 5A shows an example where a charge sharing unit does not perform charge sharing.

FIG. 5B shows an example where a charge sharing unit performs charge sharing using a short circuit between adjacent data lines.

FIG. 5C shows an example where a charge sharing unit performs charge sharing using auxiliary voltage lines.

FIG. 6 shows an exemplary voltage change caused by charge sharing.

FIG. 7 shows a display device with a plurality of data driving ICs according to an exemplary embodiment of the inventive concept.

FIG. 8 shows an exemplary data configuration packet and an exemplary feedback packet.

### DETAILED DESCRIPTION OF THE EXEMPLARY EMBODIMENTS

In the following detailed description, only certain exemplary embodiments of the present inventive concept have been shown and described. As those skilled in the art would realize, the described embodiments may be modified in various different ways, all without departing from the spirit or scope of the present inventive concept.

Like reference numerals designate like elements throughout the specification. Singular expressions, unless defined otherwise in contexts, include plural expressions. For example, the singular forms “a”, “an” and “the” are intended to include the plural forms as well, unless the context clearly indicates otherwise. In the present specification, when a constituent element is “connected” or “coupled” to another constituent element, it may be construed that the constituent element is connected or coupled to the other constituent element not only directly but also through at least one of other constituent elements interposed therebetween.

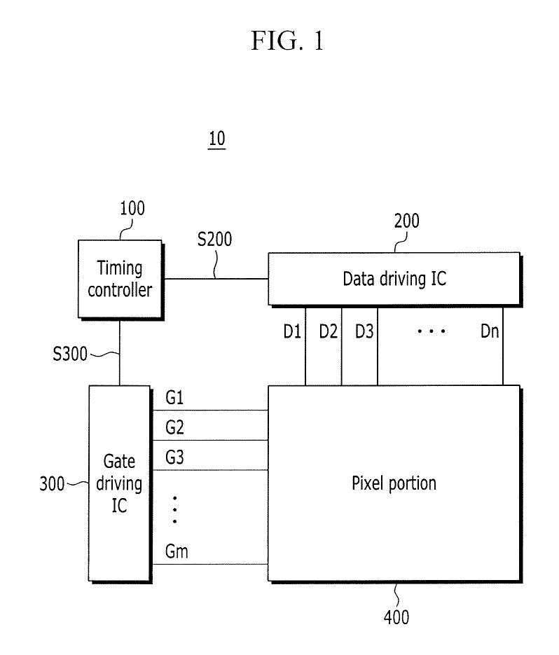

FIG. 1 shows a display device according to an exemplary embodiment of the inventive concept.

Referring to FIG. 1, the display device 10 includes a timing controller 100 (e.g., a control circuit), a data driving IC 200, a gate driving IC 300, and a pixel portion 400. The pixel portion 400 may be one of a plurality of parts of a display panel.

In an exemplary embodiment of the inventive concept, the timing controller 100 receives an external input signal that is used to generate a data configuration packet including a pixel data bit, a temperature reference voltage bit, a self-adaptive bit, and a heating control bit. In an exemplary embodiment, the pixel data bit is omitted from the data configuration packet and sent in a separate packet or message to the data driving IC 200.

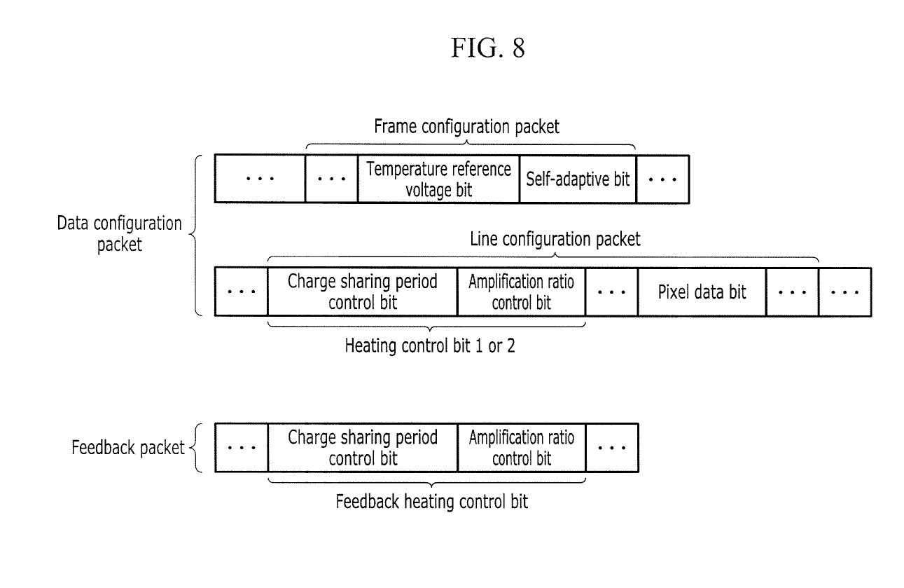

A packet represents a data unit for data communication, may be formed with a plurality of bits, and a number of bits configuring the packet may be predetermined. A bit may indicate a minimum unit, expressed as 0 or 1, for expressing information. In the present exemplary embodiment, a bit may signify a plurality of bits as well as a single bit, if necessary. In an exemplary embodiment, a plurality of bits are used to express at least three states. Therefore, the pixel data bit, the temperature reference voltage bit, the self-adaptive bit, and the heating control bit may be configured with a plurality of bits. A configuration of the data configuration packet will be described with reference to FIG. 8.

The timing controller 100 may receive an external input signal from an external graphics controller (not shown). In an exemplary embodiment, the external input signal includes an input image signal and an input control signal. The input image signal may include luminance information of each pixel of the pixel portion 400. The luminance information may include a gray scale value corresponding to one of a predetermined number (e.g., 1024, 512, 256, 128, or 64) of grays or gray scale levels. For example, the input image signal may include at least one of red image data, green image data, and blue image data. In an embodiment, the input image signal is converted into a pixel data bit. In an embodiment, the input control signal includes a vertical synchronization signal, a horizontal synchronizing signal, a main clock signal, and a data enable signal. In an embodiment, the timing controller 100 uses an external input signal to generate a data configuration packet, and transmits the generated data configuration packet to the data driving IC 200 through a signal line S200. In an embodiment, the timing controller 100 also uses the external input signal to generate a gate control signal, and transmits the generated gate control signal to the gate driving IC 300 through the signal line S300.

The data driving IC 200 receives the data configuration packet from the timing controller 100 through the signal line S200. In an embodiment, a digital signal processor included in the data driving IC 200 analyzes the data configuration packet and controls the data driving IC 200. The data driving IC 200 may generate a plurality of data voltages corresponding to the data configuration packet and may apply the same to a plurality of data lines (D1, D2, D3, . . . , Dn) for respective pixel rows.

The gate driving IC 300 receives the gate control signal from the timing controller 100 through the signal line S300. In an embodiment, the gate control signal includes a scanning start signal for instructing a scanning start, and at least one gate clock signal for controlling an output period of a gate-on voltage and/or a gate-off voltage.

The gate driving IC 300 controls on/off states of a plurality of pixel rows through a plurality of gate lines (G1, G2, G3, . . . , Gm) to control a plurality of data voltages for respective pixel rows applied by the data driving IC 200 to be programmed to the corresponding pixel rows. For example, the scanning start signal may inform the gate driving IC 300 when to begin application of gate signals to the gate lines, and a gate clock signal may inform the gate driving IC 300 how long to apply a gate-on voltage or a gate-off voltage within a given one of the gate signals.

The pixel portion 400 may include a plurality of pixels substantially arranged in a matrix form. To express or realize a given color, each pixel may express one of several primary colors (i.e., a spatial division) or may alternately express the primary colors with respect to time (i.e., a temporal division) so that a desired color may be recognized by a spatial or temporal sum of the primary colors. The primary colors may be one of three primary colors such as red, green, and blue, or may be one of three primary colors such as yellow, cyan, and magenta. A plurality of pixels displaying different primary colors may form a single set (hereinafter, a dot), and one dot may display a white image.

Each pixel may include at least one transistor connected to at least one data line and at least one gate line. When a gate line is connected to a control electrode of the transistor and the transistor is turned on, the data voltage applied to the data line is applied to the corresponding pixel through the turned-on transistor. The transistor may be turned on through application of the gate-on voltage and turned off through application of the gate-off voltage via an applied gate signal.

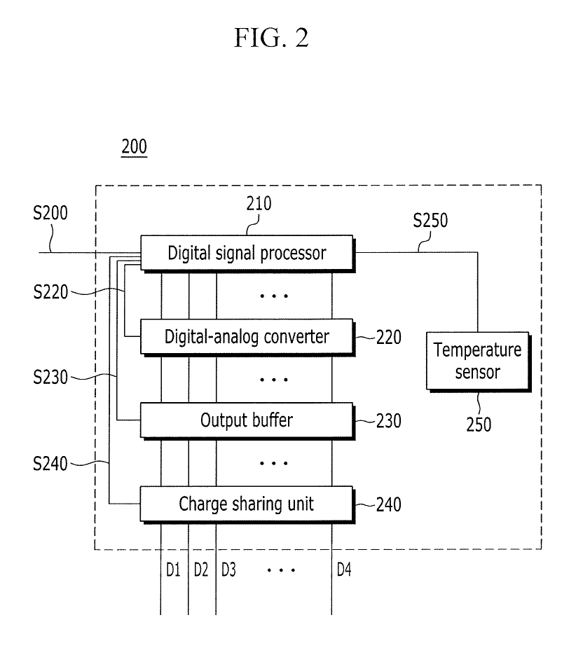

FIG. 2 shows a data driving IC of FIG. 1 according to an exemplary embodiment of the inventive concept.

Referring to FIG. 2, the data driving IC 200 includes a digital signal processor 210, a digital-analog converter 220 (e.g., a digital to analog converter), an output buffer 230, a charge sharing unit 240 (e.g., a charge sharing circuit), and a temperature sensor 250. In an embodiment where the display device 10 of FIG. 1 is a liquid crystal display, the data driving IC 200 includes the charge sharing unit 240. In an embodiment where the display device 10 of FIG. 1 is an organic light emitting device, the data driving IC 200 does not include the charge sharing unit 240. An embodiment where the display device 10 of FIG. 1 is the liquid crystal display will now be described.

The digital signal processor 210 receives the data configuration packet from the timing controller 100 through the signal line S200, and selectively generates a feedback heating control bit. The feedback heating control bit may be included in a feedback packet and may be transmitted to the timing controller 100 as feedback. For example, the digital signal processor 210 may transmit the feedback heating control bit to the timing controller 100 under certain conditions.

The digital signal processor 210 is connected to the timing controller through the signal line S200. The digital signal processor 210 is connected to the digital-analog converter 220 through a signal line S220, is connected to the output buffer 230 through a signal line S230, and is connected to the charge sharing unit 240 through a signal line S240.

The digital signal processor 210 analyzes the temperature reference voltage bit included in the data configuration packet to transmit a temperature reference voltage to the temperature sensor 250. The digital signal processor 210 may communicate with the temperature sensor 250 by using a signal line S250. For example, the temperature reference voltage bit may be configured with three bits. For example, the temperature reference voltage bit could indicate the temperature reference voltage corresponds to 85° when the temperature reference voltage bit is [000]. Further, the temperature reference voltage bit may be preset to indicate the temperature reference voltage corresponds to 100° when the temperature reference voltage bit is [001], the temperature reference voltage corresponds to 110° when the temperature reference voltage bit is [010], the temperature reference voltage corresponds to 120° when the temperature reference voltage bit is [011], the temperature reference voltage corresponds to 130° when the temperature reference voltage bit is [100], the temperature reference voltage corresponds to 140° when the temperature reference voltage bit is [101], the temperature reference voltage corresponds to 150° when the temperature reference voltage bit is [110], and the temperature reference voltage corresponds to 160° when the temperature reference voltage bit is [111]. Thus, each of the possible bit patterns of the reference voltage bit may correspond to a different temperature. While specific temperatures are described above for each specific bit pattern, the inventive concept is not limited thereto. For example, the specific temperature that corresponds to each different bit pattern supported by the temperature reference voltage bit may differ in alternate embodiments.

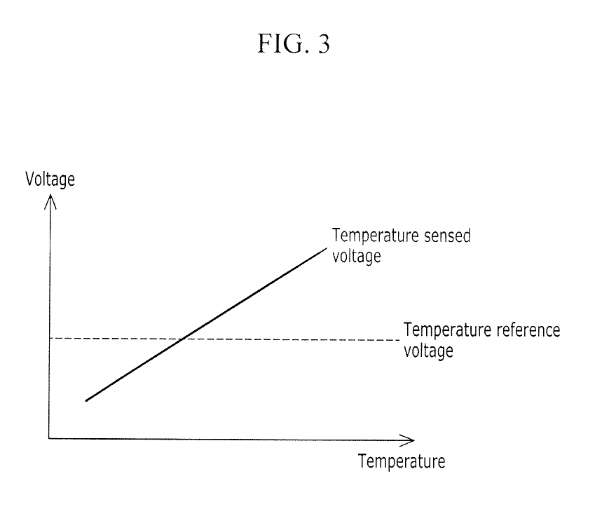

The temperature sensor 250 may be configured to sense a temperature of the data driving IC 200 and convert the sensed temperature to a corresponding temperature sensed voltage. The temperature sensor 250 may compare the temperature sensed voltage that indicates the currently sensed or measured temperature of the data driving IC 200 with the temperature reference voltage, and output a high-level abnormal temperature detecting signal when the temperature corresponding to the temperature sensed voltage is greater than the temperature associated with the temperature reference voltage (refer to FIG. 3). For example, if a temperature reference voltage of 2 volts corresponds to a temperature reference voltage bit set to a bit pattern of [100], then the high-level abnormal temperature detecting signal would be output whenever the temperature sensed voltage exceeds 2 volts to indicate the currently sensed temperature exceeds 130°. The temperature sensor 250 may output a low-level abnormal temperature detecting signal when the temperature sensed voltage is less than the temperature reference voltage. Using the same above example, the temperature sensor 250 would output a low-level abnormal temperature detecting signal when the temperature sensed voltage is less than or equal to 2 volts.

The temperature sensor 250 may include a temperature sensor for expressing the currently sensed or measured temperature of the data driving IC 200 as a temperature sensed voltage. The temperature sensor 250 may be realized by using an element of which an electrical characteristic changes according to the temperature. In an exemplary embodiment, the temperature sensor 250 is one of a diode temperature sensor, a transistor temperature sensor, and an IC temperature sensor.

The digital signal processor 210 uses the heating control bit provided by the timing controller 100 in the data configuration packet to control heating of the data driving IC 200 when the self-adaptive bit is in the OFF state.

The self-adaptive bit may be configured with a single bit and may express an ON state and an OFF state. The heating control bit may include at least one of a charge sharing period control bit and an amplification ratio control bit. The longer the charge sharing period is, the more heating of the data driving IC 200 is suppressed, and the lower the amplification ratio is, the more heating of the data driving IC 200 is suppressed.

The fact that the self-adaptive bit is in the OFF state signifies that heating control of the data driving IC 200 is not allowed and it is instructed to follow the heating control of the timing controller 100. The fact that the self-adaptive bit is in the ON state signifies that heating control of the data driving IC 200 is allowed.

When the self-adaptive bit is in the ON state and the abnormal temperature detecting signal is at a high-level, the digital signal processor 210 does not refer to the heating control bit and controls heating of the data driving IC 200 according to a feedback heating control bit. In an embodiment, the feedback heating control bit is generated by the digital signal processor 210 to ensure that the temperature measured voltage is less than the temperature reference voltage, and it may have a same structure as a heating control bit (refer to FIG. 8). In an embodiment, the feedback heating control bit may include at least one of a charge sharing period control bit and an amplification ratio control bit, and may control at least one of the charge sharing period and the amplification ratio to control heating of the data driving IC 200. For example, the feedback heating control bit may be formatted so that it reduces the next temperature sensed or measured by the temperature sensor 250.

According to a present exemplary embodiment, since the data configuration packet includes the self-adaptive bit, it may be possible to process various image patterns of the display device 10 and control heating of the data driving IC 200 independently from the control by the timing controller 100.

The digital-analog converter (DAC) 220 converts the digital image signal output by the digital signal processor 210 into an analog image signal. The digital-analog converter 220 may communicate with the digital signal processor 210 using the signal line S220. The display device 10 may further include a gray voltage generator (not shown), and the digital-analog converter 220 may use a gray voltage or a gray reference voltage generated by the gray voltage generator to generate an analog image signal. The generated analog image signal is transmitted to the output buffer 230.

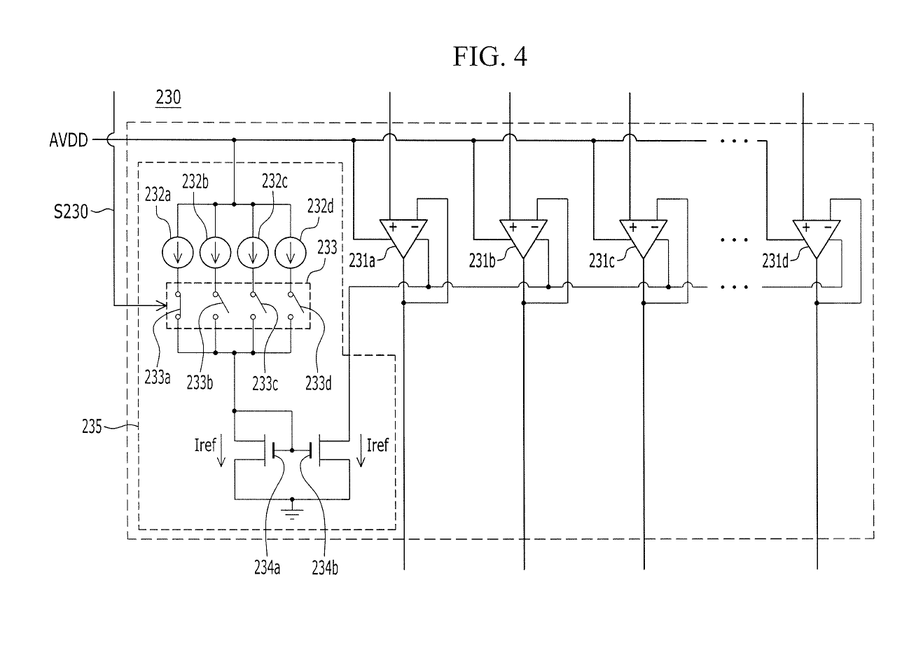

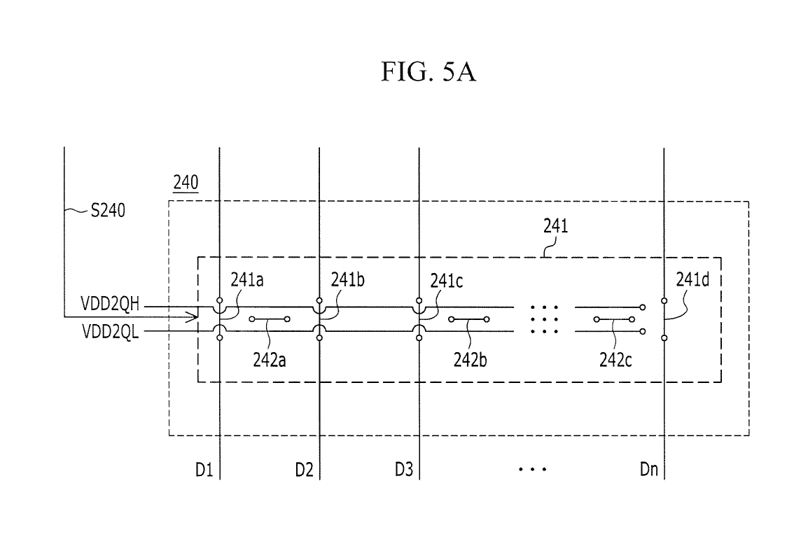

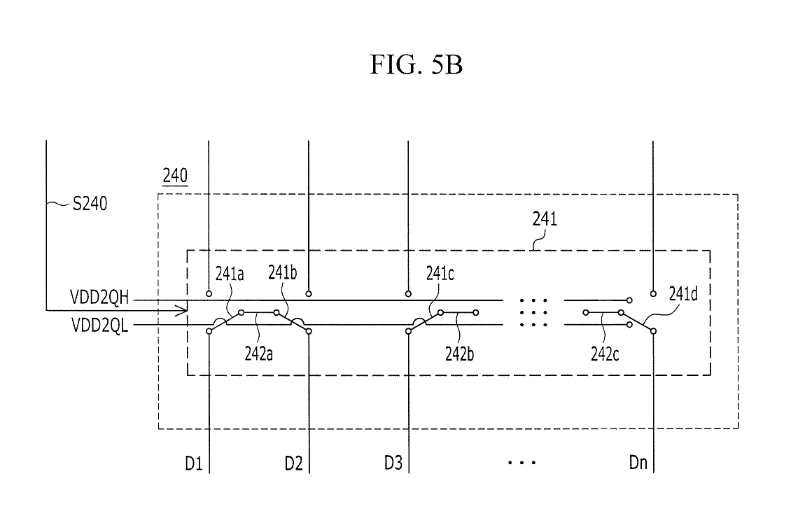

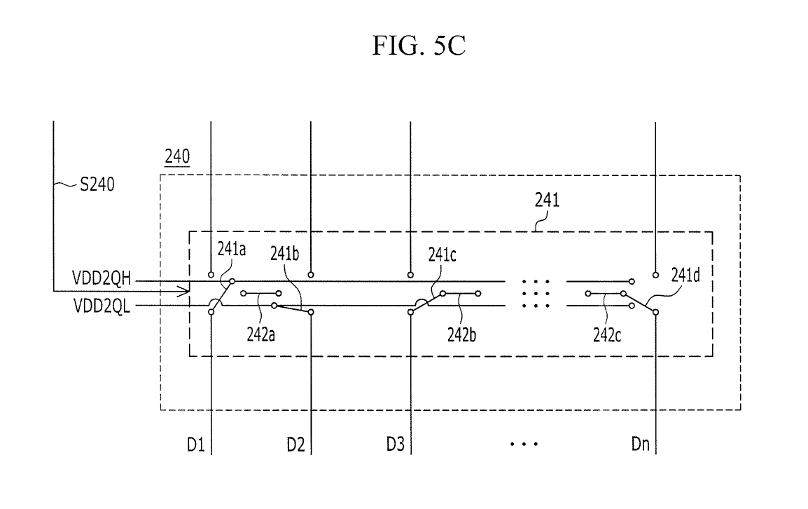

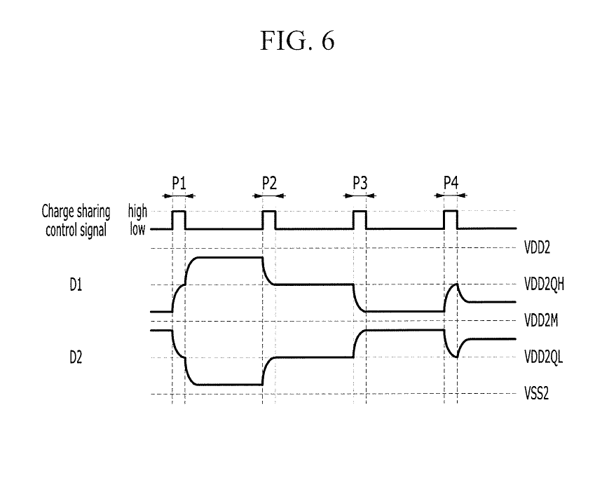

The output buffer 230 will be described with reference to FIG. 4, and the charge sharing unit 240 will be described with reference to FIG. 5A, FIG. 5B, FIG. 5C, and FIG. 6.

FIG. 4 shows an output buffer 230 according to an exemplary embodiment of the inventive concept. Referring to FIG. 4, the output buffer 230 includes a plurality of amplifiers (231a, 231b, 231c, . . . , 231d) and a power consumption (PWRC) control circuit 235.

The amplifiers (231a, 231b, 231c, . . . , 231d) are disposed corresponding to a plurality of data lines. For example, a data voltage applied to a given data line may be based on the output of a corresponding one of the amplifiers. The amplifiers (231a, 231b, 231c, . . . , 231d) may amplify an analog image signal received through non-inverting input terminals and may output it as a data voltage. Inverting input terminals of the amplifiers (231a, 231b, 231c, . . . , 231d) are connected to an output terminal. VCC terminals of the amplifiers (231a, 231b, 231c, . . . , 231d) are connected to a first power voltage AVDD. VEE terminals of the amplifiers (231a, 231b, 231c, . . . , 231d) are connected to the PWRC control circuit 235. For example, the VEE terminals may be connected to a non-gate terminal of transistor 234b of the PWRC control circuit 235 as shown in FIG. 4.

The PWRC control circuit 235 controls amplification ratios of the amplifiers (231a, 231b, 231c, . . . , 231d) to control heating of the amplifiers (231a, 231b, 231c, . . . , 231d). The lower the amplification ratio is, the more the heating of the amplifiers (231a, 231b, 231c, . . . , 231d) may be reduced.

The PWRC control circuit 235 includes transistors 234a and 234b configuring a plurality of current sources (232a, 232b, 232c, and 232d), a plurality of switches (233a, 233b, 233c, and 233d), and a current mirror circuit.

The digital signal processor 210 controls a current (Iref) by controlling a switch unit 233 through the signal line S230 according to an amplification ratio control bit. The switch unit 233 includes the switches (233a, 233b, 233c, and 233d). The current source 232a is connected in series to the switch 233a, the current source 232b is connected in series to the switch 233b, the current source 232c is connected in series to the switch 233c, and the current source 232d is connected in series to the switch 233d. Therefore, the current (Iref) is determined by the turned-on states of the switches (233a, 233b, 233c, and 233d).

When four switches (233a, 233b, 233c, and 233d) are provided in a like manner of the present exemplary embodiment, the amplification ratio control bit may be configured with two bits. FIG. 4 shows an embodiment where the amplification ratio control bit is [00], and in detail, the switch 233a is controlled to be in the ON state and is thus turned on, and the switches 233b, 233c, and 233d are controlled to be in the OFF state so the current (Tref) is determined by the current of the current source 232a. When the amplification ratio control bit is [01], the switches 233a and 233b are controlled to be in the ON state and are thus turned on, and the switches 233c and 233d are controlled to be in the OFF state so the current (Tref) is determined by the current of the current sources 232a and 232b. When the amplification ratio control bit is [10], the switches 233a, 233b, and 233c are controlled to be in the ON state and are thus turned on, and the switch 233d is controlled to be in the OFF state so the current (Tref) is determined by the current of the current sources 232a, 232b, and 232c. When the amplification ratio control bit is [11], the switches 233a, 233b, 233c, and 233d are controlled to be in the ON state and are thus turned on so the current (Iref) is determined by the current of the current sources 232a, 232b, 232c, and 232d.

FIG. 5A shows an embodiment where a charge sharing unit 240 does not perform charge sharing and FIG. 5B shows an embodiment where a charge sharing unit 240 performs charge sharing using a short circuit between adjacent data lines. FIG. 5C shows an embodiment where a charge sharing unit performs charge sharing using auxiliary voltage lines (VDD2QH and VDD2QL). FIG. 6 shows a voltage change caused by charge sharing.

Referring to FIG. 5A, FIG. 5B and FIG. 5C, the charge sharing unit 240 according to the present exemplary embodiment controls a connection among a plurality of data lines (D1, D2, D3, . . . , Dn) or a connection between a plurality of data lines (D1, D2, D3, . . . , Dn) and auxiliary voltage lines (VDD2QH and VDD2QL) to share charges.

The charge sharing unit 240 includes a switching unit 241 and auxiliary voltage lines (VDD2QH and VDD2QL). The switching unit 241 includes a plurality of switches (241a, 241b, 241c, . . . , 241d) corresponding to the data lines (D1, D2, D3, . . . , Dn). The switching unit 241 includes wires (242a, 242b, . . . , 242c) among adjacent switches (241a, 241b, 241c, . . . , 241d). The switching unit 241 may be controlled by a signal applied through the signal line 5240 connected to the digital signal processor 210, and the switches (241a, 241b, 241c, . . . , 241d) may be switched and controlled to be electrically connected to the adjacent wires (242a, 242b, . . . , 242c) or the auxiliary voltage lines (VDD2QH and VDD2QL) according to control by the digital signal processor 210.

FIG. 5A shows that the charge sharing is not performed, and a plurality of output lines of the output buffer 230 are electrically connected to a plurality of data lines (D1, D2, D3, . . . , Dn). Therefore, a data voltage that is an output of the output buffer 230 is applied to a corresponding one of the plurality of data lines (D1, D2, D3, . . . , Dn) without charge sharing with another one of the data lines. Referring to FIG. 6, during a period in which the charge sharing control signal is a low-level except the periods P1, P2, P3, and P4, a connection relationship shown in FIG. 5A is allowed.

The data voltage is controlled to swing between a voltage VDD2 and a voltage VDD2M on the data line D1, and the data voltage is controlled to swing between a voltage VDD2M and a voltage VSS2 on the data line D2. A positive data voltage is applied to the data line D1 with reference to the voltage VDD2M, and a negative data voltage is applied to the data line D2 with reference to the voltage VDD2M. To prevent degradation of liquid crystal, the negative data voltage is applied to the data line D1 and the positive data voltage is applied to the data line D2 in the next frame.

FIG. 5B shows that the charge sharing is performed by a short circuit between adjacent data lines, and in detail, the switch 241a and the switch 241b are turned on through the wire 242a according to a charge sharing control signal of the digital signal processor 210 so the data line D1 and the data line D2 are short-circuited to generate charge sharing. Other data lines (not shown) may be short-circuited from the adjacent data line to perform charge sharing. Referring to FIG. 6, a connection relationship shown in FIG. 5B is allowed during the periods P2 and P3 in which the charge sharing control signal is a high-level.

In FIG. 5C, the data lines D1 and D2 are connected to the auxiliary voltage lines (VDD2QH and VDD2QL), respectively, to perform charge sharing. Referring to FIG. 6, a connection relationship shown in FIG. 5C is allowed during the periods P1 and P4 in which the charge sharing control signal is a high-level. In detail, the data line D1 is connected to the auxiliary voltage line (VDD2QH), and the data line D2 is connected to the auxiliary voltage line (VDD2QL).

The charge sharing period control bit may indicate lengths of the periods P1, P2, P3, and P4. The longer the periods P1, P2, P3, and P4 are, the more a power amount output by the output buffer 230 is reduced so the heating of the data driving IC 200 may be reduced. The periods P1, P2, P3, and P4 may be controlled identically or differently.

One method of the charge sharing shown in FIG. 5B and the charge sharing shown in FIG. 5C may be selected, and the digital signal processor 210 may use an additional control signal to control the switching unit 241 according to the selected method.

In FIG. 6, the case in which the charge sharing control signal is a high-level is an enable level, and the case in which the charge sharing control signal is a low-level is a disable level. However, the display device according to an exemplary embodiment may use the case in which the charge sharing control signal is low-level as the enable level and the charge sharing control signal is a high-level as the disable level.

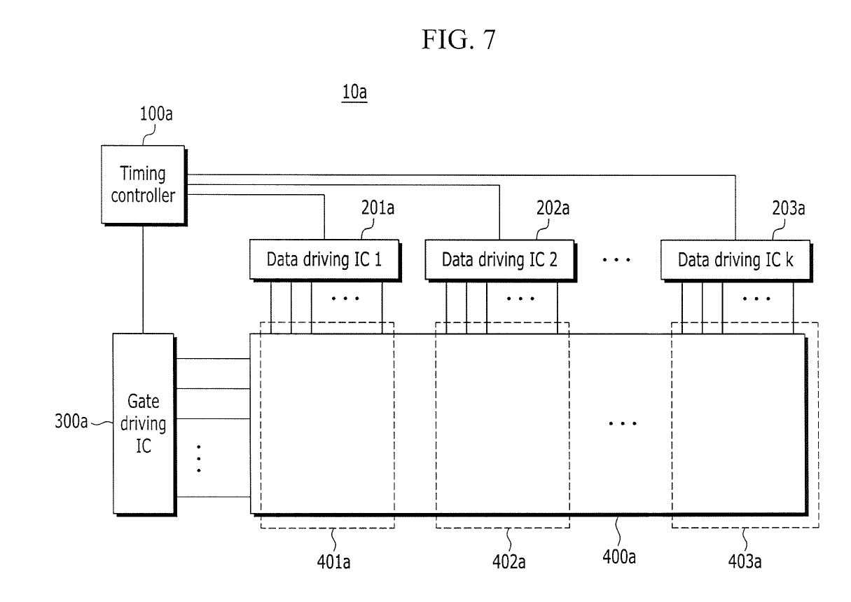

FIG. 7 shows a display device with a plurality of data driving ICs according to an exemplary embodiment of the inventive concept. Referring to FIG. 7, the display device 10a includes a timing controller 100a, a plurality of data driving ICs (201a, 202a, . . . , 203a), a gate driving IC 300a, and a pixel portion 400a. A single gate driving IC 300a is provided, but the number thereof may be plural in a like manner as a plurality of data driving ICs (201a, 202a, . . . , 203a). The display device 10a of FIG. 7 corresponds to the display device 10 of FIG. 1 except that a plurality of data driving ICs (201a, 202a, . . . , 203a) are provided.

When the driving method according to an exemplary embodiment of FIG. 1 is applied to an exemplary embodiment of FIG. 7, the respective data driving ICs (201a, 202a, . . . , 203a) ignore the heating control bit of the data configuration packet firstly received from the timing controller 100a and control the heating when the self-adaptive bit is in the ON state. The firstly received heating control bit of the data configuration packet will be referred to as a first heating control bit.

In this embodiment, when an input image signal of a pattern for causing different heating for the respective regions 401a, 402a, and 403a of the pixel portion 400a is input to the timing controller 100a, the data driving ICs (201a, 202a, . . . , 203a) may generate different feedback heating control bits and may control heating. If a voltage charging rate is different for the regions 401a, 402a, and 403a, the regions 401a, 402a, and 403a may be perceived by a viewer as different blocks.

To prevent the regions from being perceived in the above-described manner, the display device 10a of FIG. 7 may be additionally controlled as follows. The data driving ICs (201a, 202a, . . . , 203a) feed the generated feedback heating control bits back to the timing controller 100a. Each feedback heating control bit may include at least one of a charge sharing period control bit and an amplification ratio control bit. The value of the charge sharing period control bit and the amplification ratio control bit in a feedback heating control bit depends on the temperature measured by a temperature sensor 250 of a data driving IC 200. For example, if the measured temperature slightly exceeds the reference temperature, the digital signal processor 210 could set the charge sharing period control bit or the amplification ratio control bit to a smaller value, whereas if the measured temperature greatly exceeds the reference temperature, the digital signal processor could set the charge sharing period control bit or the amplification ratio control bit to a greater value. In this example, the smaller value would result in a smaller decrease in temperature of the data driving IC 200, whereas the larger value would result in a larger decrease in the temperature of the data driving IC. The timing controller 100a sets the feedback heating control bit corresponding to a maximum temperature from among the feedback heating control bits as a heating control bit of the data configuration packet, and transmits the data configuration packet to the data driving ICs (201a, 202a, . . . , 203a). For example, if the first data driving IC1 201a sent a charge sharing bit of the greater value in its feedback heating control bit to the timing controller 100a and the second-k-th data driving ICs 202a-203a sent a charge sharing bit of the lower value in their feedback heating control bits to the timing controller 100a, the timing controller 100a would set the heating control bit to the greater value and transmit it to all the data driving ICs. The heating control bit transmitted to the data driving ICs (201a, 202a, . . . , 203a) is referred to as a second heating control bit. In an exemplary embodiment, in addition to the timing controller 100a transmitting the second heating control bit to the data driving ICs, the timing controller 100a also transmits a self-adaptive bit set to the OFF state so that the data driving ICs do not ignore the second heating control bit. Heating of the data driving ICs (201a, 202a, . . . , 203a) is controlled by the second heating control bit of the data configuration packet.

Therefore, the PWRC control and the charge sharing on the data driving ICs (201a, 202a, . . . , 203a) are identically controlled according to the same heating control bit so that the blocks are not perceived by a viewer for the respective regions 401a, 402a, and 403a.

The timing controller 100a and the data driving ICs (201a, 202a, . . . , 203a) may be connected through exclusive wires in a pin-to-pin form in FIG. 7. The display device according to an exemplary embodiment further includes a bus line shared by the timing controller 100a and the data driving ICs (201a, 202a, . . . , 203a). The data driving ICs (201a, 202a, . . . , 203a) may sequentially feed the feedback heating control bit back to the timing controller 100a through the bus line.

FIG. 8 shows an exemplary data configuration packet and an exemplary feedback packet. Referring to FIG. 8, the data configuration packet transmitted by the timing controller to the data driving IC and the feedback packet fed by the data driving IC back to the timing controller are shown.

The data configuration packet may include a frame configuration packet and a line configuration packet provided after the frame configuration packet. The frame configuration packet may include a data value referred to in common by a plurality of data driving ICs. Therefore, the frame configuration packet may include a temperature reference voltage bit and a self-adaptive bit. The line configuration packet may include a data value referred to by a specific data driving IC. Therefore, the line configuration packet may include a heating control bit and a pixel data bit. The heating control bit may include a charge sharing period control bit and an amplification ratio control bit. In an embodiment, the pixel data bit includes image data for a pixel (e.g., red, green, and blue image data).

The foregoing is illustrative of the present invention and is not to be construed as limiting thereof. Although a few exemplary embodiments of the present invention have been described, those skilled in the art will readily appreciate that many modifications are possible in the exemplary embodiments without materially departing from the present invention. Accordingly, all such modifications are intended to be included within the scope of the present invention.

What is claimed is:

1. A display device comprising:
a timing controller for generating a data configuration packet comprising a temperature reference voltage bit, a self-adaptive bit, and a first heating control bit;
a data driving integrated circuit IC comprising a digital signal processor for processing the data configuration packet and a temperature sensor, and applying a data voltage corresponding to the data configuration packet to a plurality of data lines; and
a pixel portion connected to the data lines and configured to display an image,
wherein the temperature sensor senses a temperature of the data driving IC, outputs an abnormal temperature detecting signal at an enable-level when a temperature sensed voltage indicating the sensed temperature is greater than a temperature reference voltage associated with the temperature reference bit,
wherein the digital signal processor generates a feedback heating control bit to enable the temperature sensed voltage to be less than the temperature reference voltage, and
wherein the digital signal processor controls heating of the data driving IC irrespective of the first heating control bit and according to the feedback heating control bit when the self-adaptive bit is set to an ON state and the abnormal temperature detecting signal is set to the enable-level.

2. The display device of claim 1, wherein the digital signal processor controls heating of the data driving IC based on the first heating control bit when the self-adaptive bit is set to an OFF state.

3. The display device of claim 1, wherein the temperature sensor sets the abnormal temperature detecting signal to a disable-level when the temperature sensed voltage is less than or equal to the temperature reference voltage.

4. The display device of claim 2, wherein the data driving IC further comprises:
a digital-to-analog converter for converting a digital image signal output by the digital signal processor into an analog image signal; and
an output buffer comprising a plurality of amplifiers corresponding to the data lines, the amplifiers amplifying the analog image signal and outputting the data voltage,
wherein the digital signal processor controls an amplification ratio of the amplifiers according to an amplification ratio control bit present within the first heating control bit to control heating of the data driving IC.

5. The display device of claim 4, wherein the data driving IC further comprises:
a charge sharing unit electrically connected between the output buffer and the data lines,
wherein the digital signal processor controls the charge sharing unit to perform charge sharing between adjacent data lines during a period corresponding to a charge sharing period control bit present within the first heating control bit to control heating of the data driving IC.

6. The display device of claim 2, wherein the data driving IC further comprises:
a charge sharing unit electrically connected to the data lines,
wherein the digital signal processor controls the charge sharing unit to perform charge sharing between adjacent data lines during a period corresponding to a charge sharing period control bit located within the first heating control bit to control heating of the data driving IC.

7. The display device of claim 6, wherein the data driving IC further comprises:
a digital-to-analog converter for converting a digital image signal output by the digital signal processor into an analog image signal; and
an output buffer comprising a plurality of amplifiers corresponding to the data lines, the amplifiers amplifying the analog image signal and outputting the data voltage,
wherein the digital signal processor controls an amplification ratio of the amplifiers according to an amplification ratio control bit present within the first heating control bit to control heating of the data driving IC.

8. The display device of claim 1, further comprising at least one other data driving IC,
wherein the timing controller receives feedback heating control bits generated by the data driving ICs as feedback and sets the feedback heating control bit corresponding to a maximum temperature from among the feedback heating control bits as a second heating control bit, and transmits a second data configuration packet comprising the second heating control bit to all the data driving ICs for heating of the data driving ICs to be controlled by the second heating control bit.

9. The display device of claim 8,
wherein the second data configuration packet comprises a frame configuration packet and a line configuration packet provided after the frame configuration packet,
wherein the frame configuration packet comprises the temperature reference voltage bit and the self-adaptive bit.

10. The display device of claim 9, wherein the line configuration packet comprises at least one of a charge sharing period control bit and an amplification ratio control bit.

11. The display device of claim 9, wherein the self-adaptive bit is set to the OFF state.

12. The display device of claim 8, wherein a position of the first heating control bit in the data configuration packet is the same as a position of the second heating control bit in the second data configuration packet.

13. A method for driving a display device, comprising:
transmitting, by a timing controller, a data configuration packet to a data driving integrated circuit IC, the data configuration packet comprising a temperature reference voltage bit, a self-adaptive bit, and a first heating control bit;
sensing, by a temperature sensor of the data driving IC, a temperature of the data driving IC;
outputting, by the temperature sensor, an abnormal temperature detecting signal at an enable-level when a temperature sensed voltage indicating the sensed temperature is greater than a temperature reference voltage associated with the temperature reference bit;
generating, by a digital signal processor of the data driving IC, a feedback heating control bit to enable the temperature sensed voltage to be less than the temperature reference voltage ; and
controlling, by the digital signal processor, heating of the data driving IC irrespective of the first heating control bit and according to the feedback heating control bit when the self-adaptive bit is set to an ON state and the abnormal temperature detecting signal is enable-level by the digital signal processor.

14. The method of claim 13, wherein the method further comprises:
controlling, by the digital signal processor, amplification ratios of a plurality of amplifiers included in an output buffer of the data driving IC according to an amplification ratio control bit present in the first heating control bit to control heating of the data driving IC.

15. The method of claim 13, wherein the method further comprises:
controlling, by the digital signal processor, a charge sharing period of a charge sharing unit of the data driving IC according to a charge sharing period control bit present in the first heating control bit to control heating of the data driving IC.

16. The method of claim 13, wherein the method further comprises:
receiving, by the timing controller, feedback heating control bits generated by the data driving IC and least one other data driving IC as feedback;
setting, by the timing controller, the feedback heating control bit corresponding to a maximum temperature from among the feedback heating control bits as a second heating control bit; and
transmitting, by the timing controller, a second data configuration packet comprising the second heating control bit to all the data driving ICs for controlling heating of the data driving ICs according to the second heating control bit.

17. The method of claim 16,
wherein the second data configuration packet comprises a frame configuration packet and a line configuration packet provided after the frame configuration packet,
wherein the frame configuration packet comprises the temperature reference voltage bit and the self-adaptive bit, and
wherein the line configuration packet comprises at least one of a charge sharing period control bit and an amplification ratio control bit.

18. The method of claim 13, wherein a position of the first heating control bit in the data configuration packet is the same as a position of the second heating control bit in the second data configuration packet.

19. A driving apparatus for a display device, the driving apparatus comprising:
a timing controller for generating a data configuration packet comprising a temperature reference voltage bit, a self-adaptive bit, and a first heating control bit;
a temperature sensor configured to sense a temperature, output an abnormal temperature detecting signal at an enable-level when a temperature sensed voltage indicating the sensed temperature is greater than a temperature reference voltage associated with the temperature reference bit; and
a digital signal processor configured to generate a feedback heating control bit to enable the temperature sensed voltage to be less than the temperature reference voltage, and
wherein the digital signal processor controls internal heating according to the first heating control bit when the self-adaptive bit is set to an OFF state and according to the feedback heating control bit when the self-adaptive bit is set to an ON state and when the abnormal temperature detecting signal is set to the enable-level.

20. The driving apparatus of claim 19, wherein the temperature sensor sets the abnormal temperature detecting signal to a disable-level when the temperature sensed voltage is less than or equal to the temperature reference voltage.
